(19) United States
(12) Patent Application Publication
(10) Pub. No.: US 2014/0284276 A1
(43) Pub. Date: Sep. 25, 2014

(54) Sea Water Reverse Osmosis System to Reduce Concentrate Volume Prior to Disposal

(71) Applicant: Board of Regents, The University of Texas System, Austin, TX (US)

(72) Inventor: Anthony J. Tarquin, El Paso, TX (US)

(21) Appl. No.: 14/299,190

(22) Filed: Jun. 9, 2014

Related U.S. Application Data
(62) Division of application No. 12/852,240, filed on Aug. 6, 2010, now abandoned.
(60) Provisional application No. 61/233,761, filed on Aug. 13, 2009.

(51) Int. Cl. C02F 1/44

(52) U.S. Cl. CPC C02F 1/441
USPC 210/654; 210/652

(57) ABSTRACT

The present invention includes systems and methods for treatment of seawater RO system for recovering most of the water (i.e., 85-90%) from the concentrate of a brackish groundwater reverse osmosis treatment system that may use, e.g., a batch method. With proper pH control and antiscalant dosage, the batch-treatment SWRO system of the present invention can be used to recovery water from silica-saturated RO concentrate without fouling the membranes. Silica concentrations of over 1,000 mg/L are attainable with relatively minimal pre-treatment of the silica-saturated feed solution.

### CROSS-REFERENCE TO RELATED APPLICATIONS

This patent application is a divisional patent application of U.S. patent application Ser. No. 12/852,240 filed on Aug. 6, 2010 and entitled “Sea Water Reverse Osmosis System to Reduce Concentrate Volume Prior to Disposal,” which is a non-provisional patent application of and claims priority to U.S. Provisional Application Ser. No. 61/233,761 filed Aug. 13, 2009, the entire contents of which is incorporated herein by reference.

### STATEMENT OF FEDERALLY FUNDED RESEARCH

None.

### INCORPORATION-BY-REFERENCE OF MATERIALS FILED ON COMPACT DISC

None.

### TECHNICAL FIELD OF THE INVENTION

The present invention relates in general to the field of water desalination, and more particularly to the use of a sea water reverse osmosis system (SWRO) system to reduce the volume of silica-saturated, reverse osmosis (RO) or other membrane concentrate by recovering most of the water from the concentrate.

### BACKGROUND OF THE INVENTION

Without limiting the scope of the invention, its background is described in connection with the methods for treatment of brine and for reducing volumes of silica saturated membrane concentrates.

WIPO Patent Application Publication No. WO/2007/147198 (Fabig, 2007) describes a method and apparatus for improving the recovery of product liquid from a filter apparatus such as a reverse osmosis apparatus which includes operating the apparatus at or above a scaling threshold and when necessary cleaning the apparatus. The apparatus may use two units in parallel with one unit cleaning while the other unit is operating. The apparatus may be used to process reject brackish water from a reverse osmosis plant to minimize the amount of reject water.

U.S. Pat. No. 6,113,797 issued to Al-samadi (2000) discloses a high water recovery membrane purification process. The '797 patent describes a two-stage high pressure high recovery process utilizing two reverse osmosis membrane systems intended to provide very high overall water recoveries from contaminated inorganic scale-containing water in an economical manner while preventing scale formation on the membrane and prolonging the useful life of the membrane. The first stage of the process involves using a low pressure membrane system to preconcentrate scale compounds while purifying the bulk volume of the scale-containing water (using antiscalants with pH control) and combining the influent water with a recycle stream of concentrate from the second stage membrane process in order to prevent scale formation. This first stage membrane system is followed by a second stage membrane system wherein the concentrate from the first stage membrane system is treated further at higher pressure in order to provide purification of the remaining preconcentrated stream and achieve very high overall water recoveries.

U.S. Pat. No. 6,508,936 issued to Hassan (2003) describes a desalination process is which combines two or more substantially different water treatment processes in a unique manner to desalinate saline water, especially sea water, to produce a high yield of high quality fresh water, including potable water, at an energy consumption equivalent to or less than much less efficient prior art desalination processes. The '936 patent describes a process wherein a nanofiltration step is synergistically combined with at least one of sea water reverse osmosis, multistage flash distillation. multieffect distillation of vapor compression distillation to provide an integrated desalination system by which sea water can be efficiently and economically converted to high quality potable water in yields which are at least 70%-80% greater than the yields available from the prior art processes. Typically a process of this invention using the nanofiltration initial step will produce, with respect to sea water feed properties, calcium, magnesium, sulfate and bicarbonate ion content reductions of 63%-94%, pH decreases of about 0.4-0.5 units and total dissolved solids content reductions of 35%-50%.

### SUMMARY OF THE INVENTION

The present invention describes the design and the development of a pilot scale and a full-scale automated batch treatment SWRO system to reduce the volume of silica-saturated, reverse osmosis (RO) or other membrane concentrate by recovering most of the water from the concentrate.

In one embodiment, the present invention includes a small-scale system for water recovery comprising: one or more holding or feed tanks; one or more membrane units, wherein the membrane units comprise one or more semi-permeable reverse osmosis membranes; a high pressure pumping system, wherein the pumping system comprises one or more pumps operating in a recirculating mode, wherein the one or more pumps pump a concentrate from the one or more feed tanks to the one or more membrane units and also recycle the concentrate back to the feed tanks; one or more heat exchangers connected to the one or more feed tanks; a tank for collecting a final permeate; one or more optional sensors for measuring a pH, a permeate, a concentrate flow rate, a pressure, a temperature, and a conductivity; and one or more optional ancillary equipments; wherein the optional equipments are selected from the group consisting of a vacuum generator, a condenser, and a cooling tower. The system of the present invention is operated in a batch mode. In another aspect, the feed tank has a capacity of 5, 10, 20, 30, 50, 75, 100, 1,000, 10,000, 100,000, and 1,000,000, and 10,000,000 gallons. In another aspect, the concentrate is pumped from the feed tank to the membrane unit at a pressure of 100 psi, 200 psi, 500 psi, 700 psi, 800 psi, 900 psi, 1,000 and 1,200 psi. In another aspect, the concentrate is pumped from the feed tank to the membrane unit at a pressure of up to 1,200 psi, e.g., 700 psi. In another aspect, the concentrate is selected from the group consisting of a reverse osmosis concentrate, a membrane concentrate, a saline water, a brackish water, a silica-saturated water, a sea water, an inorganic-scale containing water, and a water containing one or more dissolved solids. In another aspect, the one or more semi-permeable reverse osmosis membranes comprise a spiral-wound or a hollow-fiber membrane selected from the group consisting of a polyimide membrane, a cellulose ester membrane (CEM), a charge mosaic membrane (CMM), a bipolar membrane (BPM), an anion exchange membrane (AEM), an alkali anion exchange membrane (AAEM), and a proton exchange membrane (PEM). In another aspect, the concentrate is a silica-saturated reverse osmosis concentrate, e.g., in a system increases a silica concentration in the silica-saturated reverse osmosis concentrate to less than 1,000 mg/l.

In another embodiment, the present invention includes a method of reducing a volume of a concentrate prior to disposal comprising the steps of: transferring the concentrate to a feed tank or a holding tank; feeding the concentrate from the feed tank to a membrane unit by pumping at a high pressure, wherein the membrane unit comprises one or more semi-permeable reverse osmosis membranes; passing the concentrate through the one or more semi-permeable reverse osmosis membranes; recirculating the concentrate back to the feed tank and repeating the method till a desired reduction in the volume of the concentrate is achieved; and collecting a final permeate in a permeate tank, wherein the final permeate comprises the reduced volume concentrate. In one aspect, the method includes the optional step of operating a heat exchanger attached to the feed tank to maintain a temperature of the recirculated concentrate. The step of reducing the volume of the concentrate is done in a batch mode. In another aspect, the feed tank has a capacity of 5, 10, 20, 30, 50, 75, 100, 1,000, 10,000, 100,000, and 1,000,000, and 10,000,000 gallons or more. In another aspect, the concentrate is pumped from the feed tank to the membrane unit at a pressure of up to 1,200, e.g., 700 psi. In another aspect, the concentrate is selected from the group consisting of a reverse osmosis concentrate, a membrane concentrate, a saline water, a brackish water, a silica-saturated water, a sea water, an inorganic-scale containing water, and a water containing one or more dissolved solids. Non-limiting examples of semi-permeable reverse osmosis membranes include a spiral-wound or a hollow-fiber membrane selected from the group consisting of a polyimide membrane, a cellulose ester membrane (CEM), a charge mosaic membrane (CMM), a bipolar membrane (BPM), an anion exchange membrane (AEM), an alkali anion exchange membrane (AAEM), and a proton exchange membrane (PEM). In another aspect, the concentrate is a silica-saturated reverse osmosis concentrate. In another aspect, the method has a percent recovery of 84-96%, or even, a percent recovery of 50%, 60%, 70%, 80%, 85%, 90%, 95% and 97%.

Yet another embodiment of the present invention includes a system for reducing a volume of a concentrate and for water-recovery comprising: one or more feed tanks for holding the concentrate; one or more membrane units comprising one or more semi-permeable reverse osmosis membranes; a high pressure pumping system, wherein the pumping system comprises one or more pumps for pumping the concentrate from the one or more feed tanks to the one or more membrane units and for optionally recycling the concentrate back to the feed tanks from the one or more membrane units; one or more heat exchangers connected to the one or more feed tanks; a permeate tank for collecting a final permeate; a database system contained in a computer; wherein the database system logs a reading or a measurement from the system at a specified interval or in real-time, wherein the computer is accessible via an internet at all times; one or more sensors for measuring a pH, a permeate, a concentrate flow rate, a pressure, a temperature, and a conductivity; and one or more optional ancillary equipments; wherein the optional equipments are selected from the group consisting of a vacuum generator, a condenser, and a cooling tower.

Yet another embodiment of the present invention is a method of reducing a volume and a silica concentration of a silica saturated reverse osmosis concentrate prior to disposal comprising the steps of: transferring the concentrate to a feed tank or a holding tank; feeding the concentrate from the feed tank to a membrane unit by pumping at a high pressure, wherein the membrane unit comprises four semi-permeable reverse osmosis membranes arranged in a parallel single-stage configuration; passing the concentrate through the membrane unit; recirculating the concentrate back to the feed tank and repeating the method till a desired reduction in the volume and the silica concentration of the concentrate is achieved; and collecting a final permeate in a permeate tank; wherein the final permeate comprises the reduced volume reverse osmosis concentrate having a reduced silica concentration. In one aspect, the method includes the optional step of operating a heat exchanger attached to the feed tank to maintain a temperature of the silica saturated reverse osmosis concentrate.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic showing the seawater RO pilot system of the present invention;

FIG. 2 is a plot of the flowrate vs concentrate conductivity over time for Example 1;

FIG. 3 is a plot of the flowrate vs concentrate conductivity over time for Example 2;

FIG. 4 is plot of the flowrate vs concentrate conductivity over time for Example 3;

FIG. 5 is plot of the flowrate vs concentrate conductivity over time for Example 5;

FIG. 6 is a plot of the conductivity, reactive silica, and total Silica of the feed water vs the % recovery;

FIG. 7 is a plot of permeate flow, feed conductivity, and reactive silica concentration in the feed water for a typical test run vs the % recovery;

FIG. 8 is a plot of the silica concentration vs the % concentrate recovery for nine different runs;

FIG. 9 is a plot showing the results of the regression analysis of the measured silica concentrations vs calculated theoretical concentrations;

FIG. 10 is a schematic of a full scale automated batch treatment seawater RO system;

FIG. 11 is a plot showing the effect of pH on water recovery from RO concentrate;

FIG. 12 is a plot showing the effect of acids and antiscalant on calcium sulfate precipitation; and

FIG. 13 is a plot of the SWRO costs and cash flow vs the % water recovery.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “reverse osmosis” as used herein is applied to a process wherein pressure is applied to a concentrate on one side of a semi-permeable membrane to force the entraining liquid through the pores of the membrane while the entrained material is retained on the other side of the membrane. It is called “reverse osmosis” because “osmosis” is defined as the passage of a liquid from a dilute to a more concentrated solution through the membrane, whereas “reverse osmosis” uses the same principle but, by applying pressure to the concentrated solution, forces flow of the permeate liquid in the reverse direction.

The term “membrane” is intended to include any barrier which is substantially permeable to the solvent and substantially impermeable to the solute. As used herein the term “membrane unit” means at least one membrane or a unit having a membrane module. A “membrane unit” may, for example, have a membrane module or a plurality of membrane modules connected in series or parallel or an arrangement of membrane modules connected in parallel and in series. The membrane modules used may be commercial modules. In the membrane modules, one or more membranes may be present.

The term “semi-permeable membrane” as used herein includes any semi-permeable material which can be used to separate components of a feed fluid into a permeate that passes through the material and a retentate that is rejected or retained by the material. For example, the semi-permeable material may comprise organic polymers, organic co-polymers, mixtures of organic polymers, or organic polymers mixed with inorganics. Suitable organic polymers include polysulfones; poly(styrenes), including styrene-containing copolymers such as acrylonitrile-styrene copolymers, styrene-butadiene copolymers and styrene-vinylbenzylhalide copolymers; polycarbonates; cellulosic polymers, such as cellulose acetate-butyrate, cellulose propionate, ethyl cellulose, methyl cellulose, nitrocellulose, etc.; polyamides and polyimides, including aryl polyamides and aryl polyimides; polyethers; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(alkyl acrylates), poly(phenylene terephthalate), etc; polysulfides; polymers from monomers having alpha-olefinic unsaturation other than mentioned above such as poly(ethylene), poly(propylene), poly(butene-1), poly(4-methyl pentene-1), polyvinyls, e.g. poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; etc., and interpolymers, including block interpolymers containing repeating units from the above such as terpolymers of acrylonitrile-vinyl bromide-sodium salt of para-sulfophenylmethallyl ethers; and grafts and blends containing any of the foregoing. Such organic polymers can optionally be substituted, for example, with halogens such as fluorine, chlorine and bromine; hydroxyl groups; lower alkyl groups; lower alkoxy groups; monocyclic aryl; lower acyl groups and the like. Semi-permeable membranes can also include modified versions of organic polymers. For example, organic polymers can be surface modified, surface treated, cross-linked, or otherwise modified following polymer formation, to provide additional semi-permeable materials that can be included in semi-permeable membranes. For example, see U.S. Pat. Nos. 4,584,103, 4,906,379, 4,477,634, 4,265,959, and 4,147,745 for examples of modified organic polymers.

The term “heat exchanger” used herein includes any indirect heat transfer apparatus, such as heat exchangers employed to heat or cool process fluids in the absence of chemical reaction and, particularly, heat exchangers employed in the conducting of strongly endothermic chemical reactions (dehydrogenation, cracking, etc.) and strongly exothermic chemical reactions (polymerization, isomerization, alkylation, etc.).

As used herein, the term “condenser” is used to describe any vessel providing indirect heat transfer from a gaseous flow so as to effect the liquefaction of a portion of that flow. The term “cooling tower” as employed herein includes all systems in which water is utilized as a fluid or liquid coolant over heat transfer surfaces. The term includes cooling towers of all configurations and heat rejecting equipment where water is circulated from a reservoir and sprays or falls over heated material. It involves air movement and evaporative cooling of the water.

A “batch mode” as used herein refers to a processing or manufacturing operation wherein all the components are assembled at one step in a group before moving the group to the next and other subsequent steps of the production process.

The terms “saline water” or “brine” as used herein broadly includes water containing any substantial concentration of dissolved inorganic salts, regardless of the particular concentration. Thus, “saline water” or “brine” may broadly refer to water containing anywhere from about 1,000 ppm to high percentages of dissolved salts. The term “brackish water” refers to water having an amount of dissolved salts greater than 0.5 grams per liter. The term “brackish water” can also encompass salt water.

As used herein, the term “spiral wound membrane” refers to a structure wherein a membrane sandwich, such as two flat sheet membranes that are separated by a flat sheet porous channel spacer member, is wound about a centrally-located product water or permeate collection tube, to thereby assume a convenient cylindrical form that is then placed into a hollow, cylindrical shaped, outer housing member. Prior to winding, three sides of the membrane sandwich are glued together, and the fourth side is glued into the product water collection tube. A feed water stream is passed into one end of the cylindrical module and along one side of the wound membrane sandwich. This feed water permeates the membrane and passes into the channel spacer member as product water. The product water travels in a spiral, until it reaches the center or longitudinal axis of the module. There, the product water flows through small holes that are formed in the product water collection tube, whereupon the water exits the module through a product water outlet. Retentate that does not permeate the membrane exits the module through an outlet at the opposite end of the module. Generally, in a spiral wound membrane, the individual layers of the spiral-wound membrane do not experience the same magnitude of liquid pressure or pressure differential.

The term “hollow fiber module” as used herein includes structures wherein a relatively large number of elongated, small diameter, and hollow membrane tubes are packed into a cylindrically shaped, high pressure, housing, such that the elongated central cavity of all tubes extending in a common direction from one end of the housing to the other. A feed water stream is passed into the housing and along the outer cylindrical surfaces of all tubes. This feed water permeates the membrane tubes. Product water then travels through the center of all membrane tubes, until it reaches one end of the housing. There, the product water exits the housing through a product water outlet. Retentate that does not permeate the membrane tubes exits the housing module through a retentate outlet that is located at this other end of the housing. In general, all membrane tubes experience the same magnitude of liquid pressure or pressure differential.

The present invention describes a seawater RO treatment of RO Concentrate to extreme silica concentrations. Severe restrictions exist in the disposal of the concentrate from the 15 mgd (2370 m³/h) reverse osmosis (RO) plant in El Paso, Tex. (i.e., 15 mgd blended to 27.5 mgd). The current permit for the disposal by deep well injection limits the total dissolved solids in the brine to 10,000 mg/l. This limits water recovery in the plant and drives up the cost of sending a large volume of the concentrate a long distance for discharge.

The present inventors have developed a concentrate treatment process aimed at zero liquid discharge or a greatly reduced concentrate volume suitable for evaporation ponds. This disclosure documents the demonstration of the feasibility of using a seawater RO system and synergistic antiscalant and low pH inhibition of reactive silica polymerization to concentrate the primary brackish water RO concentrate to total silica concentrations up to and exceeding 1,000 mg/l. The approach of the present invention makes possible the use of tandem brackish RO followed immediately by a seawater RO (SWRO) process to achieve an overall water recovery of greater than 96%, limited only by the highest pump pressures to overcome the resulting osmotic pressures.

Pilot plant data using a single, seawater RO membrane and 700-740 psi feed pressure concentrating the brackish RO concentrate in a batch recirculation mode is described in this disclosure. Recoveries of water in the 84-96% range were performed repeatedly with no apparent fouling of the membrane and no precipitation in the super-concentrate. The flux reduction curves in each case were consistent with gradual reduction of net driving pump pressure due to the rise in osmotic pressure that needs to be overcome. The reactive and total silica concentration profiles provided insights on the effects on membrane operation during buildup of reactive silica concentration with or without the increasing amounts of colloidal polymeric hydrated silica expected from the spontaneous polymerization of the reactive silicic acid monomer.

A problem faced by inland communities who undertake brackish water desalting projects is what to do with the concentrate that is generated in the process (the most common disposal option of surface water discharge is obviously not available to inland communities). Research funded by the U.S. Bureau of Reclamation and others indicated that it might be economically feasible to recover additional water from silica-saturated RO concentrate through lime treatment followed by second-pass RO, thereby possibly rendering evaporation and/or other options more viable.

The present disclosure describes the use of a vibratory process technology and a batch-treatment seawater reverse osmosis (SWRO) system to recover additional water from the silica-saturated RO concentrate that is generated at the Kay Bailey Hutchison (KBH) desalting plant in El Paso, Tex. The location of the 15 mgd (2370 m³/h) capacity RO plant in a land-locked highly populated region makes the design of an acceptable concentrate disposal process a challenging task. Variable salinity in well waters reaching above 1500 mg/l and a cap of 10,000 mg/l allowed for deep-well injection of the concentrate restricts the degree of salinity concentration, hence limiting the maximum water recovery rate of the plant. The need for water conservation and the high cost of pumping the concentrate waste to a distant injection well provide strong incentives for developing an alternate, and more economic method, of treating the RO reject.

The results showed that while a vibratory process technology could be used, the SWRO option was preferable from economic and operational points of view. By reducing the pH and using an antiscalant for calcium sulfate control, recoveries in the 85-90% range were achieved with the SWRO system without fouling the membranes. Reactive silica concentrations of over 1,000 mg/L were measured in the concentrated concentrate.

Implementation of a full-scale SWRO system as described in the present disclosure at the KBH plant would generate an additional four million gallons of water per day at a cost of less than $1.87 per thousand gallons. At 85% recovery of concentrate, there would be net cash flow exceeding $178,000 and the overall water recovery at the plant would increase to 97%.

The present inventors have reported the pilot-scale demonstration of an overall recovery of 97% of water by operating the primary RO at 85-90% recovery, followed by lime-softening of the concentrate then a second RO in tandem for another high recovery¹. The recovery-limiting foulant in the primary RO was shown to be silica, and lime-softening greatly reduced the silica concentration.

A problem faced by any inland water desalting facility deals with the disposal of the brine solution that is generated in the reverse osmosis process. The problem is exacerbated when the raw water supply contains substances that could foul membranes if an excessive amount of permeate is extracted for the brackish feed water. This is the case in the city of El Paso, where the brackish groundwater contains silica at an average concentration of 25-30 mg/L. At this concentration, recovery of product water will be limited to about 75% (if no antiscalants are used) because above this value, silica will precipitate, fouling the membranes. Since the KBH plant uses an antiscalant, the plant is operated at a recovery of 80%, which results in a concentrate volume of about 3 million gallons per day with a silica concentration of 125 mg/L. At the present time, the concentrate is disposed of via injection wells located 23 miles from the plant.

Two different pilot-scale studies done by the present inventor²⁻³ funded by the U.S. Bureau of Reclamation and EPWU showed that it was economically feasible to recover over 80% of the silica-saturated brine concentrate through lime precipitation of some of the silica. Both studies were conducted at the same pilot plant site that was used for collecting design information for the KBH plant.

Spontaneous polymerization of silicic acid in water, generally referred to as molybdate-reactive silica, form larger and larger polymeric non-reactive silica species in water in colloidal forms⁴⁻¹⁰. Silica fouling is a major challenge to the operation and maintenance of brackish water Ros¹¹⁻¹². Laboratory studies discerned parameters that affect the severity of silica fouling^{7,8,10,13-14}. Antiscalants and antifoulants are introduced aimed at inhibiting the rate of polymerization of reactive silica or at the dispersion of colloidal silica^{12,15-16}.

The objective of the present invention is, to greatly reduce the volume of the primary RO concentrate, with the use of acidification to reduce silica polymerization rate as an alternative to the lime-softening approach reported earlier. In the laboratory, it has been shown that silicic acid polymerization is severely retarded by acidic pHs¹⁷ as suggested in the literature^{6,9}, and that pH control can be synergistic with antiscalant action¹⁷. In the present disclosure, the inventors report an approach by which total silica concentrations exceeding 1,000 mg/l can be attained with a seawater RO in tandem with the primary brackish water RO. By injecting an acid into the seawater RO feed along with an antiscalant, an overall recovery of 96% was reached as a continuous process using a tandem RO. In the El Paso water, studies in the present invention the limiting factor for higher recovery is projected to be the osmotic pressure that needs to be overcome by the anticipated 1,000 psi limit of a seawater RO system.

The efficiency of a tandem RO process that can concentrate the total dissolved solids (TDS) in brackish waters to the maximum 1,000 psi of osmotic pressure in the concentrate is highly desirable. Continuous operation without stoppage to treat the intermediate concentrate of the primary RO eliminates the time given to super-saturated brine to deposit foulants. Rapid concentration of dissolved salts improves the conditions in which the fractionation of the less soluble multivalent salts of calcium, magnesium, barium and strontium can be optimized, leaving the more soluble monovalent sodium and potassium behind for further concentration and recovery.

The present disclosure describes a continuous tandem RO process to reach an overall water recovery of 96% (or higher with a higher pressure pump), total silica concentration exceeding 1,000 mg/l and TDS at least double the seawater range. The system of the present invention can be used for longer periods of continuous operation, and minimized antiscalant and acid dosages. Data on the fractionation of salts from the super-concentrate will be reported elsewhere.

The KBH desalination plant takes well water from the Hueco Bolson aquifer and filters it through a sand strainer and 5 micron cartridge filter before the RO plant. An antiscalant (Pretreat Plus-Y2K) with silica polymerization inhibitor activity is injected at a 4 ppm dosage. Five membrane banks with the capacity of producing 3 mgd (474 m³/hr) each of permeate gave a total capacity of 15 mgd (2370 m³/hr) of permeate and 3 mgd (474 m³/hr) of concentrate at a recovery rate of 82%. The typical composition of the blended well water entering the plant and the concentrate are given in Table 1. The concentrate was pumped more than 20 miles across the desert to three deep well injection sites, where it is then distributed downward into a fractured rock formation of low quality water more than 3,500 feet (1070 meters) below the surface. The discharge permit currently limits the maximum TDS of the concentrate to 10,000 mg/l, a very difficult and expensive situation for the plant. During the piloting period, the primary RO recovery of 86-90% was attained¹.

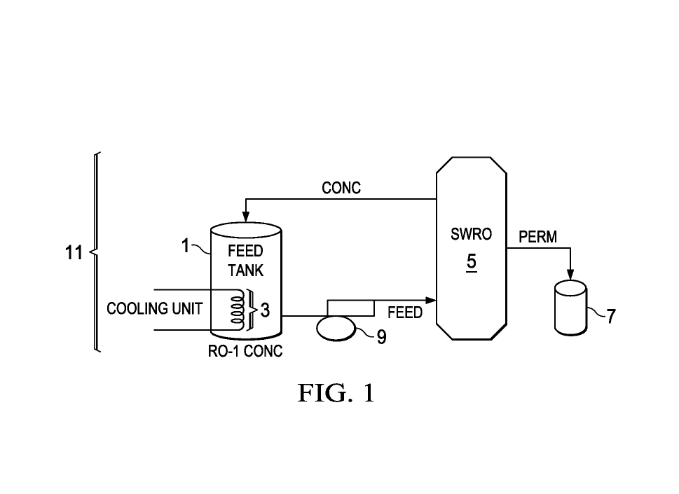

Seawater RO pilot studies: A schematic of the SWRO test system 11 used to concentrate the primary RO concentrate in a batch operation mode is shown in FIG. 1. Concentrate from the KBH plant was put into a 30-gallon (114 liter) holding/feed tank 1. The concentrate was acidified with sulfuric acid to pH 3-5 in the tank 1 along with the addition of an antiscalant (Pretreat Plus-0400) for controlling extremely high sulfate scaling potentials. The solution was fed into the SWRO unit 5 at 700 psi, using a high pressure pumping system 9 in a recirculation mode. The concentrate recycled back to the feed tank 1 until the desired recovery was achieved. A heat exchanger 3, kept the feed solution from getting too hot. The SWRO permeate was collected in tank 7.

Representative data from five runs performed under different conditions on different days are presented. In each case, the concentration process was carried to near the limit of the net-driving pressure required by the pump to overcome osmotic pressure. The super-concentrates remained clear, and the membrane did not appear to foul. Initial fluxes remained the same at the start of each run with just a simple rinse out with permeate water.

TABLE 1
KBH Concentrate Characteristics.

| | | | | | | | | | | % |
|---|---|---|---|---|---|---|---|---|---|---|
| | 2007 | | | 2008 | | | 2009 | | | Change |
| Parameter | Min | Average | Max | Min | Average | Max | Min | Average | Max | ′07-′09 |
| Cl | 2400 | 4239 | 8890 | 265 | 4699 | 9710 | 4840 | 5089 | 5540 | 20.1% |
| SO₄ | 453 | 896 | 1970 | 127 | 1039 | 2110 | 1050 | 1111 | 1200 | 23.9% |
| ALK-P | 0 | 0 | 0 | 2.5 | 6.9 | 12.5 | 0 | 0 | 0 | |
| ALK-T | 266 | 424 | 499 | 18.8 | 412 | 498 | 400 | 427 | 445 | 0.6% |
| Ba | 0.042 | 0.31 | 0.48 | | | | | | | |
| B | 0.028 | 0.11 | 0.17 | | | | | | | |
| CL₂-F | 0.05 | 0.09 | 0.16 | 0.05 | 0.07 | 0.09 | | | | |
| CL₂-T | 0.05 | 0.11 | 0.27 | 0.05 | 0.06 | 0.1 | | | | |
| EC | 1640 | 15185 | 23400 | 1040 | 16267 | 22100 | 16600 | 18122 | 20200 | 19.3% |
| Fe | 0.03 | 0.11 | 0.6 | 0.03 | 0.13 | 0.57 | 0.03 | 0.07 | 0.12 | −36.4% |
| T Hard | 1180 | 1898 | 3770 | 528 | 2089 | 3030 | 2050 | 2291 | 2430 | 20.7% |
| Mn | 0.09 | 0.17 | 0.23 | 0.1 | 0.16 | 0.21 | 0.11 | 0.17 | 0.22 | −0.3% |
| ortho-P | 0.1 | 0.16 | 0.27 | 0.1 | 0.16 | 1.26 | 0.11 | 0.19 | 0.49 | 21.4% |
| pH | 7.5 | 7.9 | 8.1 | 7.1 | 8.0 | 8.3 | 7.6 | 7.8 | 8.0 | −1.4% |
| Ca | 303 | 516 | 1100 | 376 | 589 | 793 | 281 | 608 | 937 | 17.8% |
| K | 45.5 | 74 | 114 | 4.9 | 76 | 99.7 | 43 | 113 | 759 | 53.4% |
| Mg | 88.8 | 140 | 258 | 0.9 | 153 | 208 | 85.7 | 161 | 183 | 14.9% |
| Na | 208 | 2398 | 4220 | 172 | 2674 | 4200 | 1730 | 2810 | 3260 | 17.2% |
| Sr | 8.74 | 17.1 | 30.1 | | | | | | | |
| SiO₂ | | | | 28.7 | 148 | 228 | 26.9 | 131 | 173 | |
| TDS | 6890 | 8738 | 15300 | 6740 | 10412 | 13200 | 10300 | 10722 | 11200 | 22.7% |
| CALC-TDS | 1070 | 9867 | 15200 | 677 | 10566 | 14400 | 10800 | 11772 | 13100 | 19.3% |
| Temp | 20.5 | 21.9 | 24 | 18.9 | 24.1 | 221 | 23.3 | 25.4 | 26.3 | 15.8% |
| Turb | 0.07 | 0.22 | 1.62 | 0.08 | 0.85 | 14.6 | 0.06 | 0.30 | 1.94 | 34.3% |
| | | | | | | | | | Avg = | 15.5% |

### Example I

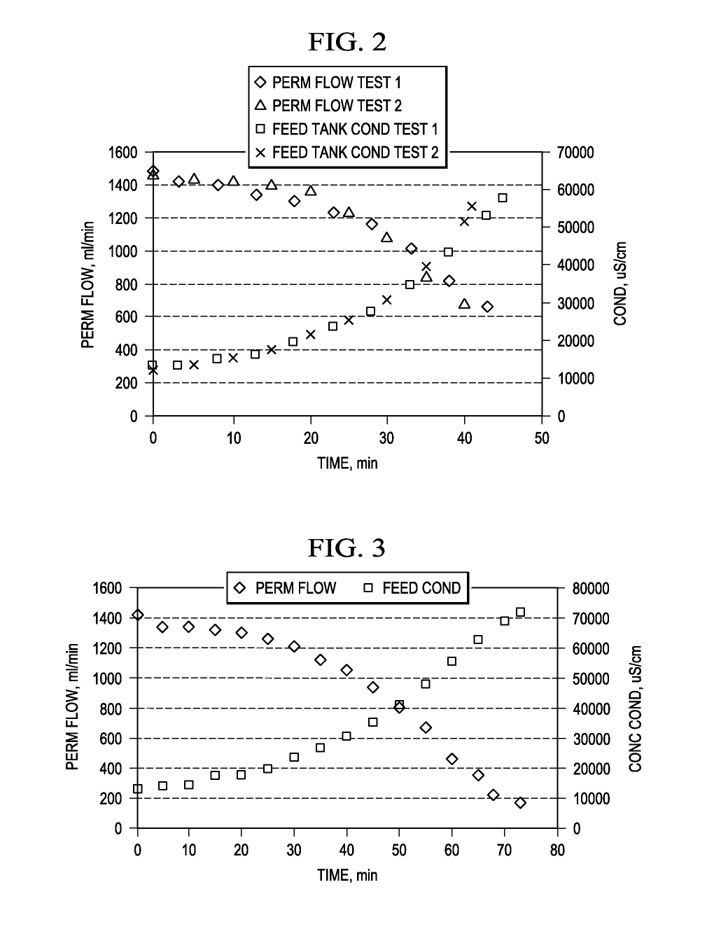

Procedure: Run 1 was started with 15 gallons of plant RO concentrate, to which 0.3 mls of Pretreat Plus-0400 antiscalant was added, and concentrated sulfuric acid was added to lower the pH to 3.7-4.0. The concentrate was further concentrated with about 93% recovery of permeate (14 gallons) using a 700 psi pump pressure over about 42 minutes. The permeate flowrate vs concentrate conductivity over time are plotted and is shown in FIG. 2.

Observations: No turbidity or precipitation was visible in the resulting super-concentrate. The absence of fouling of the membrane was indicated by two facts. One, the fall-off of the permeate flowrate was smooth coinciding with the gradual increase in the osmotic pressure exerted by the concentrate against the 700 psi pressure of the concentrating pump. Secondly, to refresh membrane for another run, brief flushing with the collected permeate fully restored the initial membrane flux. The conductivity of the collected permeate after stirring to mix were 203 and 263 microS/cm for the replicate runs. The corresponding super-concentrate conductivities were, 56,200 and 60,800 respectively, representing average salt passage of about 0.4%.

### Example II

Procedure: The same conditions of Run 1 above were repeated, the run time was extended to 73 minutes. Starting volume of the plant RO concentrate was 20 gallons. The permeate flowrate and concentrate conductivity over time are plotted as shown in FIG. 3.

Observations: Again the super-concentrate showed no visible turbidity or precipitation. A total of 19.35 gallons of permeate produced from 20 gallons of plant RO (primary RO) concentrate represents 96.8% recovery in the secondary seawater RO. The final mixed permeate had a conductivity of 450 microS/cm, and the concentrate 71,900 microS/cm. The average salt passage in this run is 0.6%.

### Example III

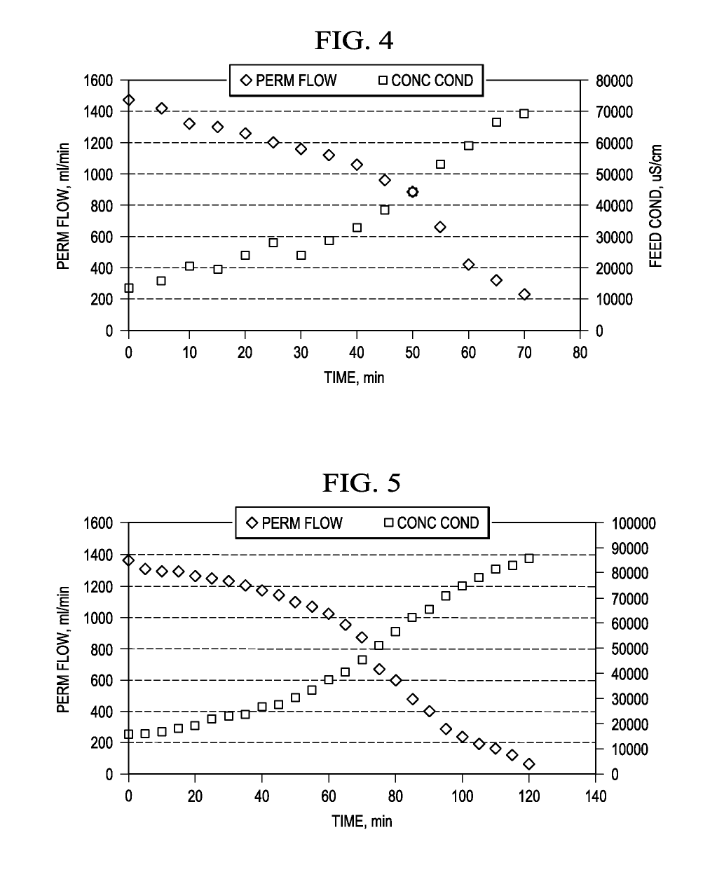

Procedure: The run started with 10 gallons of plant RO concentrate, and 1.0 ml of Pretreat Plus-0400, followed by two 5-gallon increments of plant RO concentrate at 10 minutes and 25 minutes time points, each time adjusting the pH to 3.7-4.2 with concentrated sulfuric acid. The permeate flowrate at 700 psi and concentrate conductivity over 70 minutes are plotted as shown in FIG. 4.

Observations: Again the super-concentrate showed no visible turbidity or precipitation, and the membrane showed no evidence of fouling by silica. A simple flushing of the system with RO permeate water cleaned the membrane which retained the original productivity (840 mls/minute at 300 psi). From the initial 20 gallons of plant RO concentrate, the final mixed permeate volume was 18.05 gallons (500 microS/cm) and the final concentrate volume was 1.34 gallons (71,500 microS/cm). This represented an apparent recovery of 93% and average salt rejection of 99.3%. Reactive silica (by Hach molybdate assay) in the super-concentrate was measured in triplicate as 870, 790 and 810 mg/l.

### Example IV

Procedure: The run started with 10 gallons of plant RO concentrate, and 1 ml of Pretreat Plus-0400, followed by three 5 gallon increments of plant RO concentrate at 7, 17 and 27 minute time points, each time adjusting to pH 3.1 to 3.3 range with concentrated sulfuric acid. The permeate flowrate at 700 psi and concentrate conductivity over 102 minutes showed similar gradual fall off of permeate flowrate of 1350 mls/minute to 80 mls/minute, while the concentrate conductivity increased from 13,810 to 82,600 microS/cm.

Observations: Again the super-concentrate showed no visible turbidity or precipitation, and the membrane showed no evidence of fouling by silica. A simple flushing of the system with RO permeate water cleaned the membrane which retained the original productivity (840 mls/minute at 300 psi). From the initial 25 gallons of plant RO concentrate, the final mixed permeate volume was 23.52 gallons and final concentrate volume was 1.27 gallons (82,600 microS/cm). This represented an apparent recovery of 95%. Reactive silica profile (by Hach molybdate assay) in the concentrate was measured as 110 and 115 mg/l at start, 340 and 390 mg/l at 52 minutes, and 880 and 980 mg/l at 92 minutes.

### Example V

Procedure: The run started with 30 gallons of plant RO concentrate, and 0.3 ml of Pretreat Plus-0400, adjusting to pH 3.65 with concentrated sulfuric acid. The permeate flowrate at 700 psi (accidently increasing to 740 psi after 70 minutes), and concentrate conductivity over 120 minutes showed similar gradual fall off of permeate flowrate of 1360 mls/minute to 68 mls/minute, while the concentrate conductivity increased from 15,740 to 86,100 microS/cm. The permeate flowrate and concentrate conductivity over 120 minutes are plotted in FIG. 5.

Observations: Again the super-concentrate showed no visible turbidity or precipitation, and the membrane showed no evidence of fouling by silica. A simple flushing of the system with RO permeate water cleaned the membrane which retained the original productivity (840 mls/minute at 300 psi). From the initial 25 gallons of plant RO concentrate, the final mixed permeate volume was 27.43 gallons and final concentrate volume was 2.38 gallons (86,100 microS/cm). This represented an apparent recovery of 92%. Reactive silica profile (by Hach molybdate assay) in the concentrate was measured as 110 mg/l at start, 260, 255 and 285 mg/l at 55 minutes, and 700, 780 and 780 mg/l at 105 minutes. The total dissolved solids in the super-concentrate were determined by drying in the oven. The results were: 73,880, 73175 and 72475 (average: 73,183 mg/l).

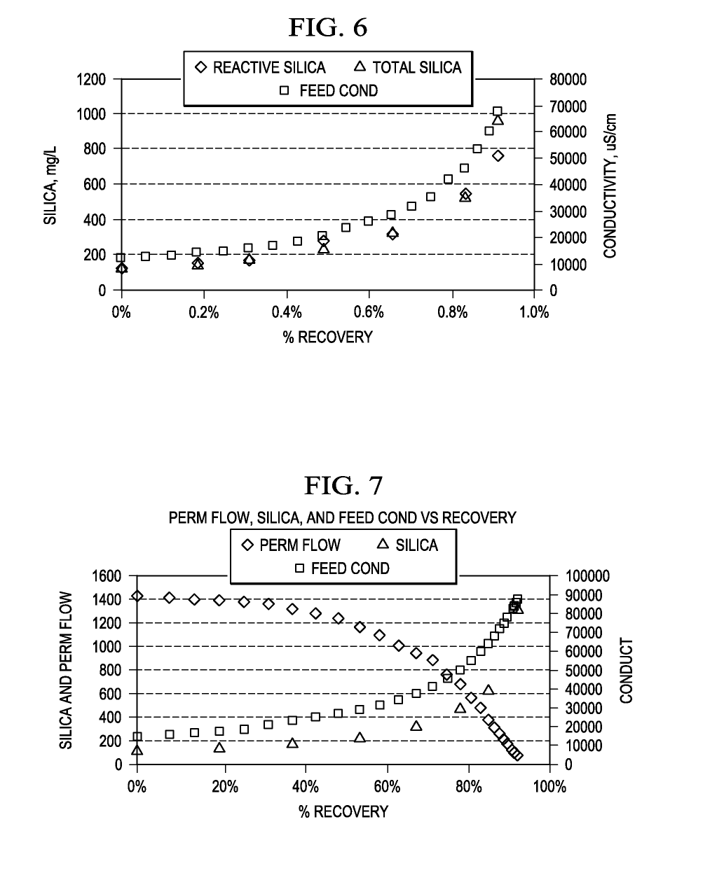

Silica concentration profile in the process: During the design phase of the current RO plant, the inventors showed that in the pilot studies silica was the limiting foulant for water recovery between 85-90%¹. Now, using the effect of acidification of the primary RO concentrate in synergy with the antiscalant to inhibit the polymerization of reactive silica which triggers fouling, the inventors have for the first time in RO process designed a chemical control that can circumvent the fouling effects of high silica concentrations in brackish water. It is of interest to clearly document the concentration profiles of reactive and total silica⁸ whose effects on RO membranes apparently have been completely controlled. A composite picture of the silica profile in this process is given in Table 2 and are shown in FIG. 6.

TABLE 2
Feed Conductivity and Silica versus Percent Recovery.

| Percent | Feed Conductivity | Reactive Silica | Total Silica |
|---|---|---|---|
| Recovery (%) | (uS/cm) | (mg/L) | (mg/L) |
| 0 | 11,690 | 123 | 130 |
| 18.6 | 13,760 | 153 | 149 |
| 31.0 | 15,340 | 172 | 179 |
| 48.8 | 19,780 | 280 | 235 |
| 65.6 | 28,300 | 318 | 328 |
| 83.2 | 45,700 | 545 | 528 |
| 91.3 | 67,400 | 765 | 965 |

Table 2 shows the conductivity of the feed water along with the reactive silica and total silica concentrations at various point in a batch run (the total silica concentration was calculated from silicon concentrations measured using Inductively Coupled Plasma, ICP, Spectroscopy). The data show that reactive silica and total silica concentrations were almost exactly the same for all recoveries except the last one at 91.3%. The difference is due to polymerization of the silica (which would not show up in the reactive silica measurement).

The performance of the system was excellent, with no precipitation of salts until the recovery reached about 92%. FIG. 7 is a plot of permeate flow, feed conductivity, and reactive silica concentration in the feed water for a typical test run (all silica concentrations in this disclosure are reactive silica unless noted otherwise). The decrease in permeate flow rate was due to the increase in the osmotic pressure of the feed solution as it became more concentrated. The final conductivity of the feed solution was 87,000 μS/cm at a recovery of 92%. Salt(s) began to precipitate just before the test was stopped. The silica concentration in the feed solution was over 1300 mg/L, which is more than 400 mg/L higher than any of the silica concentrations measured in previous runs.

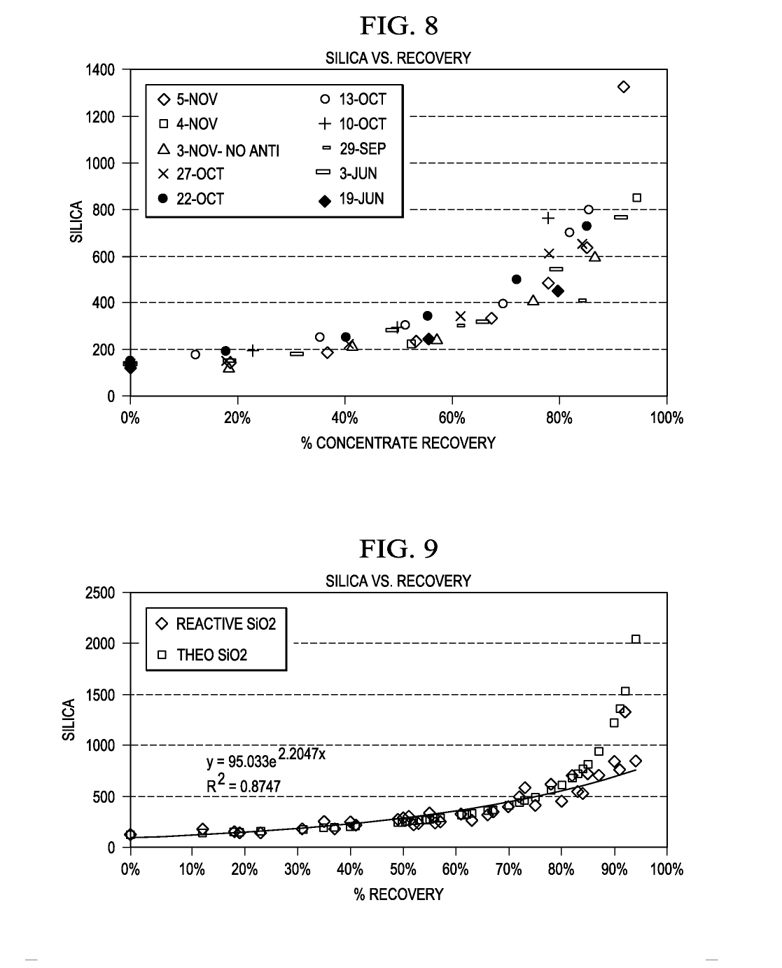

FIG. 8 is a plot of silica concentration versus recovery for nine different runs. These data were combined and plotted to obtain a least squares equation as shown in FIG. 9. The measured and calculated silica concentrations for nine different runs are plotted in the graph and they are very close until about 80% recovery, after which the values begin to diverge. This is because the silica begins to polymerize at about that point, and the test that measures reactive silica (HACH molybdate assay) does not measure polymeric silica. This explanation is supported by the data in Table 3 which shows the reactive silica concentrations and total silica concentrations for one run where total silica was measured by Inductively Coupled Plasma (ICP) Spectroscopy. The reactive and total silica concentrations were about the same up to 80% recovery, but at 91%, the total silica concentration is more than 26% higher than the reactive silica concentration. As stated previously, this is the recovery range where salt precipitation begins, so it is likely that approximately 90% recovery is about as far as the seawater RO process can go in recovering additional water from KBH concentrate.

TABLE 3
Reactive Silica and Total Silica (by ICP).

| | Reactive Silica | Total Silica | |
|---|---|---|---|
| Recovery | (mg/L) | (mg/L) | % Difference |
| 0 | 123 | 130 | 5.8% |
| 18.6% | 153 | 149 | −2.5% |
| 31.0% | 172 | 179 | 4.0% |
| 48.8% | 225 | 235 | 4.3% |
| 65.6% | 318 | 328 | 3.2% |
| 79.3% | 525 | 528 | 0.5% |
| 91.3% | 765 | 965 | 26.2% |

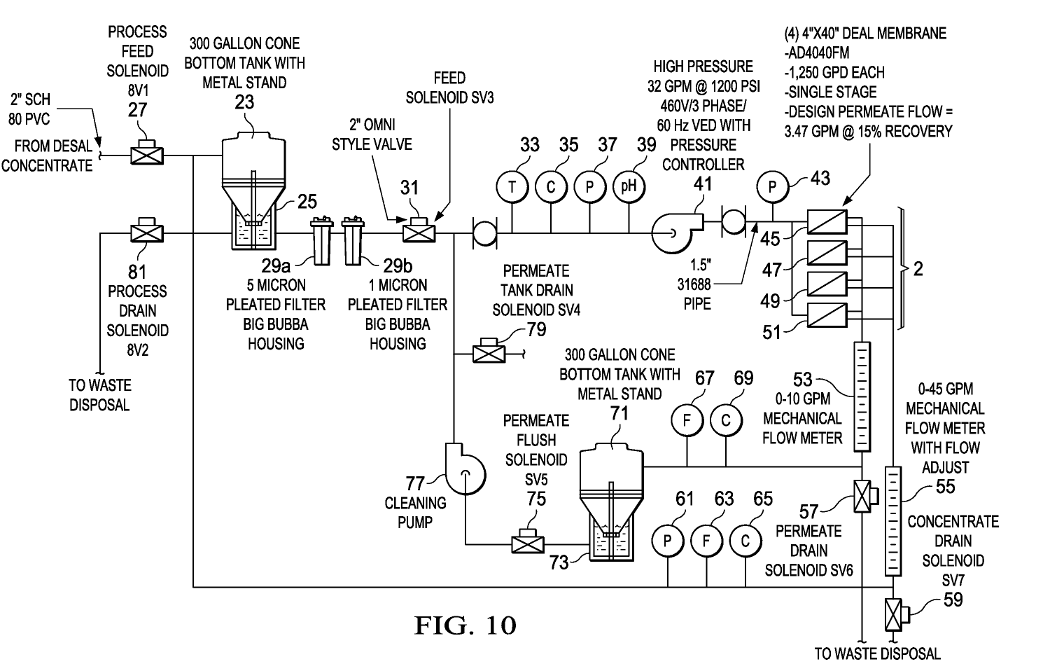

Full scale SWRO system: Following the successful tests of the small SWRO unit, a larger fully automated batch-treatment system was installed and tested. A schematic of the system is shown in FIG. 10.

The system had four 4″×40″ GE-Osmonics desal membranes in a parallel single stage configuration. The concentrate feed tank and permeate collection tank are 300-gallon cone-bottom plastic tanks on metal stands. The high pressure positive displacement feed pump discharged 32 gpm at 1,200 psi and produce up to 6 gpm of permeate at the normal operating pressure of 700 psi. The system includes numerous sensors for measuring pH, permeate and concentrate flow rates, pressures, temperatures, and conductivities. The readings are data-logged at one minute intervals and were stored on a computer that is accessible at all times via the internet.

FIG. 10 is a schematic of a full scale SWRO system. Feed tank 23 is mounted on a metal stand 25, and it receives the RO concentrate the flow of which is regulated through a solenoid valve 27. From the feed tank 23, the concentrate flows through 5μ and 1μ prefilters 29a and 29b. Solids and other wastes are removed and sent to the waste disposal through solenoid valve 81. The filtered feed is sent to a high pressure pump 41, through a feed solenoid valve 31. The temperature, conductivity, pressure, and the pH of the feed flowing to the pump 41, is monitored through sensors 33, 35, 37, and 39 respectively. The feed then is passed through a membrane unit 2, comprising four membranes 45, 47, 49, and 51, arranged in a parallel single stage configuration. A pressure sensor 43 monitors the pressure of the feed passing through the membrane. The feed after passing through the unit 2, is split into two streams. The first stream the flow rate of which is measured by a flow meter 55 splits into two, (i) the waste stream regulated by a solenoid valve 59, (ii) recirculation stream which is fed back to the feed tank 23. The pressure, flow, and conductivities of the recirculation feed is measured by sensors 61, 63, and 65, respectively. The flow rate of the second stream is monitored by a flow meter 53, and it further splits into two, (i) the waste regulated by valve 57, (ii) permeate which flows to permeate tank 71, mounted on a metal stand 73. The flow and the conductivity of the permeate feed is measured by sensors 67 and 69 respectively. Part of the permeate from the permeate tank 71, is passed through a cleaning pump 77, through solenoid valve 75, and is allowed to drain through drain solenoid valve 79.

Table 4 shows the characteristics of the initial KBH concentrate, the total permeate, and the final concentrate from a run that was set for 80% recovery. The TDS of the total permeate is very low at less than 200 mg/L, rendering the water very blendable. The iron concentration in the final feed is higher than it should be based on the calculated theoretical concentration for 80% recovery, indicating that iron is being picked up somewhere in the treatment system itself. All of the other parameter concentrations are about as expected, indicating that the system performed as anticipated from the results obtained with the smaller SWRO pilot unit.

TABLE 4
Characteristics of initial feed, permeate, and final concentrate.

| Parameter | KBH Conc | Permeate | Final Feed |
|---|---|---|---|
| Calcium | 274 | <10 | 1432 |
| Iron | 0.14 | <0.02 | 5.5 |
| Magnesium | 92.2 | 1.5 | 438 |
| Potassium | 48 | <2 | 216 |
| Sodium | 1910 | 44.7 | 8640 |
| Chloride | 5520 | 126 | 26600 |
| Sulfate | 1230 | 9.8 | 8140 |
| Elec Cond | 19900 | 902 | 99000 |
| TDS | 11200 | 164 | 57800 |
| pH | 7.8 | 3.2 | 3.6 |
| Silica | 126 | <5 | 728 |

The inventor also studied the effect of other variables in conjunction with a vibratory process and SWRO studies, including the effect of pH on water recovery, the effectiveness of an antiscalant for inhibiting sulfate precipitation, and the effect of feed water temperature on the capital cost of the seawater system.

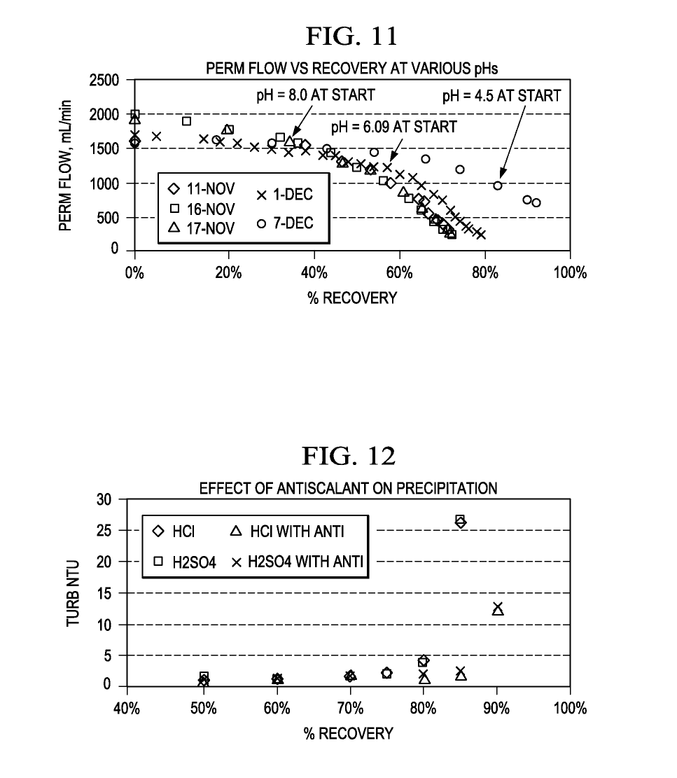

Effect of pH on Recovery: In order to evaluate the effect of pH on water recovery from RO concentrate, the pH was adjusted to 8.0, 6.09, and 4.5 and fed into a vibratory process unit until precipitation began. The results are shown in FIG. 11. The data clearly showed that as the pH was reduced, the recovery increased before precipitation occurred.

Antiscalant and Acid Evaluation: In conventional membrane processes, water recovery from brackish water solutions is limited by precipitation of the least soluble salt. In the case of KBH concentrate, electron microscopic analysis of the solids that precipitated from highly concentrated RO concentrate revealed that the solids were primarily calcium sulfate. The seawater RO process that was used in this study required that the pH of the feed solution be reduced from about 8.0 to below 4.0. Two commonly used acids for doing so are hydrochloric and sulfuric. Hydrochloric acid has the advantage of not adding sulfates to the treated water, but it is harder to handle (because of its tendency to fume) and it is only one third the strength of sulfuric acid. Conversely, sulfuric acid does not fume and is less expensive than hydrochloric acid. In order to determine if the type of acid used to lower the pH would significantly affect the point where calcium sulfate precipitation would occur, laboratory tests were conducted wherein the recovery was simulated in KBH concentrates that were treated with each type of acid. Various amounts of calcium chloride and sodium sulfate were added to vigorously-stirred solutions of KBH concentrate and then checked for salt precipitation by measuring the turbidity of the solutions. In addition to evaluating the effect of acid type on calcium sulfate precipitation, an antiscalant intended to inhibit calcium sulfate precipitation was also tested. The antiscalant Pretreat Plus 0400 that is available through King Lee Technologies was used in the evaluation. It was added at 5 ppm to two samples of KBH concentrate that had the pH reduced to 3.5, one with sulfuric and the other with hydrochloric acid.

The results of the tests are plotted in FIG. 12. The graph shows that precipitation occurred at approximately 80% recovery in each of the acid-only solutions. The law of mass action dictates that the solution having the higher sulfate concentration should precipitate first, but the 5% increments in recovery that were utilized in the testing protocol were apparently not precise enough to detect the difference in precipitation points. In any case, for our purposes, the advantages that sulfuric acid has over hydrochloric acid (including a huge cost differential) would favor using sulfuric acid for reducing the pH of the feed solution.

When the antiscalant was added in addition to the acid, the results show that the antiscalant did indeed allow for more recovery of water from the concentrate before precipitation began. Regardless of which acid was used in pre-treating the concentrate, precipitation did not occur until a recovery of about 86% was achieved. The difference between 80% and 86% recovery represents only a 6% increase in recovery of water, but perhaps more significantly for inland systems, it represents a 30% reduction in the volume requiring final disposal. This would obviously have a meaningful impact on the cost of concentrate management when evaporation is used for disposal of the final concentrate. Thus, the use of the antiscalant for inhibiting calcium sulfate precipitation in the KBH concentrate appears to well founded.

In addition to the lab-scale testing of the effectiveness of the antiscalant, comparative tests were conducted at the pilot plant site by running KBH concentrate through both a vibratory process and the seawater RO units with and without antiscalant treatment. The pilot scale results showed that more water could be extracted from the concentrate when using the antiscalant. That is, without the antiscalant, precipitation generally occurred at conductivities below 64,000 μS/cm, which corresponds to a recovery of between 70% and 85%, depending on the strength of the concentrate at the beginning of the test. When the antiscalant was used, concentrate conductivities of over 75,000 μS/cm were attained without precipitating anything from the feed solution (in one test, the conductivity of the final concentrate was over 86,000 μS/cm). Thus, the pilot scale results confirmed the laboratory tests, demonstrating that the antiscalant was very effective at inhibiting calcium sulfate precipitation.

Process Economics. In considering the economics of the batch-treatment SWRO concentrate recovery process, the values used in the calculations are, at best, reflective of the costs at a certain place and at a given point in time. Nevertheless, similar projects at other locales would have much in common with this project, so the cost estimates obtained here should represent a good guide as to what to expect in similar projects at other places, especially after prudent adjustments for time and place have been made. The calculations that follow do not include other technology because the capital cost of the system would be at least five times more than a comparably-sized SWRO system. Furthermore, a vibratory process technology is best used for feedwaters that contain suspended solids, and that was not the case in this project.

The values associated with the parameters used in deriving the costs for a full-scale project are shown in Table 5. Cost-related components that are not included in this project but may have to be included in projects considered elsewhere are land costs, pipeline costs, and solids disposal costs. These components are not included herein because of circumstances that may be unique to this project, but their impact on total costs will be discussed below.

TABLE 5
Values used in calculating cost of water
recovered from RO concentrate.

| Item | Value |
|---|---|
| Initial RO conc volume (gpd) | 3,000,000 |
| Interest rate (%) | 5% |
| Evap rate (in/yr) | 50 |
| Liner cost, $/sq ft | 0.60 |
| Liner life, yrs | 20 |
| Excavation, $/cu yd | $3.00 |
| Fence, $/LF | $10.00 |
| Flow storage, mos | 6 |
| Excavation & fence amortztn time, | 20 |
| yrs | |
| Equipment life, yrs | 20 |
| Water selling price, $/1,000 gal | $2.00 |
| Blending well depth, ft | 300 |
| Blending ratio (total vol/RO perm) | 1.5 |
| SWRO membrane life | 5 |
| RO capital cost, $/MGD | $700,000 |
| Power cost, $/kw-hr | $0.08 |
| Pump & Motor efficiency, % | 75% |
| Buildings, $ | $320,000 |
| RO membrane cost, $/sq ft | $2.00 |
| SWRO flux, gpd/sq ft | 15 |
| SWRO operating pressure, psi | 700 |
| Antiscalant, $/9 lb gallon | $11 |
| H₂SO₄, $/gal | $2.53 |
| H₂SO₄ feed rate, mL/gal | 1.0 |
| Personnel cost, $/yr 6@$35,000 | $210,000 |
| Contingencies, $/yr | $200,000 |

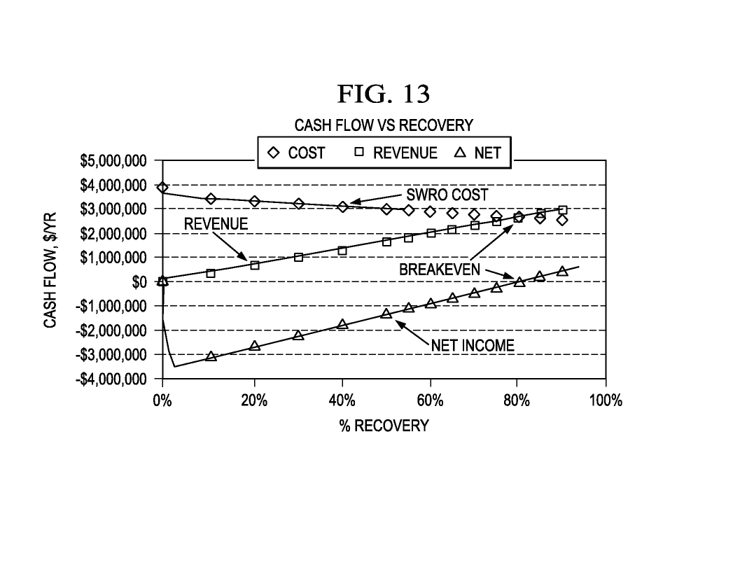

The results of the cost calculations as a function of water recovery are shown in FIG. 13. The breakeven point occurs at a recovery a little above 80%. At recoveries above the breakeven point, there is positive cash flow to the utility.

The values associated with the various recoveries are shown in Table 6. At a recovery of 85% (which has been shown to be feasible for this project), the cost of the recovered water would be $1.87 per thousand gallons and the utility would have a positive cash flow of $178,000 per year. The net positive cash flow at 90% would be over $400,000 per year. Inclusion of items that were not considered here such as land cost would add about $0.05 per thousand gallons of product water for each $1 million of capital cost.

In addition to the positive cash flows associated with the project, there would be an extra 3.8 MGD of drinking water produced from the RO concentrate that would otherwise be thrown away (at additional cost). Thus, a batch-treatment seawater reverse osmosis system for recovering water from the RO concentrate at the KBH Desalination plant appears to be very attractive from an economic point of view.

TABLE 6
Product water costs as a function of percent recovery.

| | Product Water Cost | Net Revenue, |
|---|---|---|
| Recovery % | ($/1,000 gal) | ($/yr) |
| 0 | | 0 |
| 10% | $22.50 | −$3,367,933 |
| 20% | $10.81 | −$2,895,492 |
| 30% | $6.92 | −$2,422,983 |
| 40% | $4.97 | −$1,950,393 |
| 50% | $3.80 | −$1,477,701 |
| 55% | $3.37 | −$1,241,306 |
| 60% | $3.02 | −$1,004,872 |
| 65% | $2.72 | −$768,391 |
| 70% | $2.46 | −$531,852 |
| 75% | $2.24 | −$295,240 |
| 80% | $2.04 | −$58,532 |
| 85% | $1.87 | $178,311 |
| 90% | $1.72 | $415,365 |

For the El Paso KBH Desalination RO plant, the present invention represents a first step towards the development of a process to greatly reducing the volume of RO reject that has to be disposed, and by an alternate method without using deep well injection. Very beneficial is the visualization of the use of sequential ROs in tandem to concentrate all brackish well waters continuously to the maximum limits of 1,000 to 1,200 psi seawater RO, at nearly 100% water recovery rates where the resulting osmotic pressure in the concentrate cannot be overcome. These results show in principle that a non-stop tandem RO process with near complete water recovery is possible. The super-concentrate resulting from such a process would still be brines that contain less than 10% by weight of dissolved salts. Such salt concentrations will facilitate the fractionation of less soluble calcium and magnesium salts from the more soluble sodium and potassium salts of some commercial value. The economics of zero-liquid-discharge from large inland municipal waterworks can be made feasible, and the control of salinity influx from the use of river waters such as exists in the arid southwestern US dealt with.

Synergistic effects of antiscalants and acids allow for non-stop recovery of pure water from brackish sources using a seawater RO system following a primary RO. The tandem RO system of the present invention is capable of recovering pure water to the limits of backflow osmotic pressures resulting from the use of 1,000-1,200 psi feedwater pumps driving against it.

The batch-treatment seawater RO system of the present invention is very effective for recovering most of the water (i.e. 85-90%) from the concentrate of the brackish groundwater reverse osmosis treatment system at the KBH desalting plant in El Paso, Tex. With proper pH control and antiscalant dosage, the batch-treatment SWRO system of the present invention can be used to recovery water from silica-saturated RO concentrate without fouling the membranes. Silica concentrations of over 1,000 mg/L are attainable with relatively minimal pre-treatment of the silica-saturated feed solution. A vibratory process technology can be used to recover water from silica-saturated RO concentrate, but a SWRO system of the present invention is much more attractive from a capital cost and system-maintenance point of view.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

WIPO Patent Application Publication No. WO/2007/147198: Brine Squeezer.
U.S. Pat. No. 6,113,797: High water recovery membrane purification process.
U.S. Pat. No. 6,508,936: Process for desalination of saline water, especially water, having increased product yield and quality.
1. R. Y. Ning, A. Tarquin, M. C. Trzcinski and G. Patwardhan, Recovery optimization of RO concentrate from desert wells, Desalination, 201 (2006) 315-322.
2. Tarquin, A., “Volume Reduction of High-Silica RO Concentrate Using Membranes and Lime Treatment”, U.S. Department of the Interior, Bureau of Reclamation, DWPR Report No. 108, February 2005.
3. Tarquin, A., “Cost Effective Volume Reduction of Silica-Saturated RO Concentrate”, U.S. Department of the Interior, Bureau of Reclamation, DWPR Report No. 125, March 2006.
4. G. B. Alexander, The reaction of low molecular weight silicic acid with molybdic acid, J. Amer. Chem. Soc., 75 (1953) 5655-5657.
5. J. D. Burton, T. M. Leatherland and P. S. Liss, The reactivity of dissolved silicon in some natural waters, Limnology and Oceanography, 15/3 (1970) 473-476.
6. R. K. Iler, The chemistry of silica: solubility, polymerization, colloid and surface properties, and biochemistry, Wiley-Interscience, New York, N.Y. (1979).
7. I. Bremere, M. Kennedy, S. Mhyio, A. Jaljuli, G-J. Witkamp and J. Schippers, Prevention of silica scale in membrane systems: removal of monomer and polymer silica, Desalination, 132 (2000) 89-100.
8. R. Y. Ning, Discussion of silica speciation, fouling, control and maximum reduction, Desalination, 151 (2002) 67-73.
9. T. Coradin and P. J. Lopez, Biogenic silica patterning: simple chemistry or subtle biology, Chem. Bio. Chem., 3 (2003) 1-9.
10. R. Semiat, I. Sutzkover and D. Hasson, Scaling of RO membranes from silica supersaturated solutions, Desalination, 157 (2003) 169-191.
11. R. Y. Ning and P. T. L. Shen, Observations from analysis of reverse osmosis membrane foulants, Ultrapure Water, 15/4 (1998) 37-40.
12. E. G. Darton, RO plant experiences with high silica waters in the Canary Islands, Desalination, 124 (1999) 33-41.
13. R. Sheikholeslami and S. Tan, Effect of water quality on silica fouling of desalination plants, Desalination, 126 (1999) 267-280.
14. D. Lisitsin, D. Hasson and R. Semiat, Critical flux detection in a silica scaling RO system, Desalination 186 (2006) 311-318.
15. R. Y. Ning, Process simplification through the use of antiscalants and antifoulants, Ultrapure Water, 20/7 (2003) 17-20.
16. R. Y. Ning, T. L. Troyer and R. S. Tominello, Chemical control of colloidal fouling of reverse osmosis systems, Desalination, 172 (2005) 1-6.
17. R. Y. Ning, unpublished results.

What is claimed is:

1. A method of reducing a volume of a concentrate prior to disposal comprising the steps of:
transferring the concentrate to a feed tank or a holding tank;
feeding the concentrate from the feed tank to a membrane unit by pumping at a high pressure, wherein the membrane unit comprises one or more semi-permeable reverse osmosis membranes;
passing the concentrate through the one or more semi-permeable reverse osmosis membranes;
recirculating the concentrate back to the feed tank and repeating the method till a desired reduction in the volume of the concentrate is achieved; and
collecting a final permeate in a permeate tank, wherein the final permeate comprises the reduced volume concentrate and the percent (%) recovery is at least 50%, 60%, 70%, 80%, 85%, 90%, 95% or 97%.

2. The method of claim 1, comprising the optional step of operating a heat exchanger attached to the feed tank to maintain a temperature of the recirculated concentrate.

3. The method of claim 1, wherein the reduction in the volume of the concentrate is done in a batch mode.

4. The method of claim 1, wherein the feed tank has a capacity of 5, 10, 20, 30, 50, 75, 100, 1,000, 10,000, 100,000, and 1,000,000, and 10,000,000 gallons.

5. The method of claim 1, wherein the concentrate is pumped from the feed tank to the membrane unit at a pressure of between 700 and 1,200 psi.

6. The method of claim 1, wherein the concentrate is pumped from the feed tank to the membrane unit at a pressure of 100 psi, 200 psi, 500 psi, 700 psi, 800 psi, 900 psi, 1,000 and 1,200 psi.

7. The method of claim 1, wherein the concentrate is selected from the group consisting of a reverse osmosis concentrate, a membrane concentrate, a saline water, a brackish water, a silica-saturated water, a sea water, an inorganic-scale containing water, and a water containing one or more dissolved solids.

8. The method of claim 1, wherein the one or more semi-permeable reverse osmosis membranes comprise a spiral-wound or a hollow-fiber membrane selected from the group consisting of a polyimide membrane, a cellulose ester membrane (CEM), a charge mosaic membrane (CMM), a bipolar membrane (BPM), an anion exchange membrane (AEM), an alkali anion exchange membrane (AAEM), and a proton exchange membrane (PEM).

9. The method of claim 1, wherein the concentrate is a silica-saturated reverse osmosis concentrate.

10. The method of claim 1, wherein the method has a percent recovery of 84-96%.

11. A method of reducing a volume and a silica concentration of a silica saturated reverse osmosis concentrate prior to disposal comprising the steps of:
transferring the concentrate to a feed tank or a holding tank;
feeding the concentrate from the feed tank to a membrane unit by pumping at a high pressure, wherein the membrane unit comprises four or more semi-permeable reverse osmosis membranes arranged in a parallel single-stage configuration;
passing the concentrate through the membrane unit;
recirculating the concentrate back to the feed tank and repeating the method till a desired reduction in the volume and the silica concentration of the concentrate is achieved; and
collecting a final permeate in a permeate tank; wherein the final permeate comprises the reduced volume reverse osmosis concentrate having a reduced silica concentration and the percent (%) recovery is at least 50%, 60%, 70%, 80%, 85%, 90%, 95% or 97%.

12. The method of claim 11, comprising the optional step of operating a heat exchanger attached to the feed tank to maintain a temperature of the silica saturated reverse osmosis concentrate.

13. The method of claim 11, wherein the reduction in the volume and the silica concentration of the concentrate is done in a batch mode or in a continuous mode.

14. The method of claim 11, wherein the feed tank and the permeate tank have a capacity of 5, 10, 20, 30, 50, 75, 100, 1,000, 10,000, 100,000, and 1,000,000, and 10,000,000 gallons.

15. The method of claim 11, wherein the silica saturated reverse osmosis concentrate is pumped from the feed tank to the membrane unit at a pressure of between 700 and 1,200 psi.

16. The method of claim 11, wherein the silica saturated reverse osmosis concentrate is pumped from the feed tank to the membrane unit at a pressure of 100 psi, 200 psi, 500 psi, 700 psi, 800 psi, 900 psi, 1,000 and 1,200 psi.

17. The method of claim 11, wherein the four semi-permeable reverse osmosis membranes comprises a spiral-wound or hollow-fiber membrane selected from the group consisting of a polyimide membrane, a cellulose ester membrane (CEM), a charge mosaic membrane (CMM), a bipolar membrane (BPM), an anion exchange membrane (AEM), an alkali anion exchange membrane (AAEM), and a proton exchange membrane (PEM).

18. The method of claim 11, wherein the method has a percent recovery of 84-96%.

19. The method of claim 11, wherein the method increases a silica concentration in the silica-saturated reverse osmosis concentrate up to 1,000 mg/l.

20. A method of reducing a volume and a silica concentration of a silica saturated reverse osmosis concentrate prior to disposal comprising the steps of:
transferring the concentrate to a feed tank or a holding tank;
feeding the concentrate from the feed tank to a membrane unit by pumping at a high pressure, wherein the membrane unit comprises four or more semi-permeable reverse osmosis membranes arranged in a parallel single-stage configuration;
passing the concentrate through the membrane unit;
recirculating the concentrate back to the feed tank and repeating the method till a desired reduction in the volume and the silica concentration of the concentrate is achieved; and
collecting a final permeate in a permeate tank; wherein the final permeate comprises the reduced volume reverse osmosis concentrate having a silica concentration in the silica-saturated reverse osmosis concentrate up to 1,000 mg/l and the percent (%) recovery is at least 50%, 60%, 70%, 80%, 85%, 90%, 95% or 97%.
